(19) United States
(12) Patent Application Publication
(10) Pub. No.: US 2003/0065795 A1
(43) Pub. Date: Apr. 3, 2003

(54) Computer system and method for managing remote access of user resources

(76) Inventors: Luca Bortoloso, Genova (IT); Stefano Dighero, Genova (IT)

Correspondence Address: Siemens Corporation, Intellectual Property Department, 186 Wood Avenue South, Iselin, NJ, 08830, US

(21) Appl. No.: 10/046,804

(22) Filed: Jan. 15, 2002

(30) Foreign Application Priority Data
Sep. 28, 2001 (EP) 01123485.3

(51) Int. Cl. G06F 15/16

(52) U.S. Cl. 709/229; 709/203

(57) ABSTRACT

A computer for managing access of a user to resources having a first database for storing of users and/or of groups of users. One or more script files are generated containing information descriptive of a user resource. A centralized user manager program accesses the first database and the script file(s). A remote computer is coupled to the central computer. Included in the central computer is an application program for accessing a local user management program. The local user management program creates a local resources database for authentication and access right authentication of the user during the login procedure.

This Application claims the benefit of the earlier filing date of European Patent Application, Serial No. 01123485.3 filed on Sep. 28, 2001, which is hereby incorporated by reference.

### FIELD OF THE INVENTION

The present invention relates to managing user resources and, more particularly, to a computer system and method for managing access of user resources.

### RELATED INFORMATION

User management and authentication is a key issue in access of remote resources. Indeed, with respect to Industrial Controllers, such as Process Control Systems (PCS) and Manufacturing Execution Systems (MES), denying or granting an outside user access to controller resources is a critical issue. If access is erroneously granted to the wrong individual, the resources, and perhaps an entire industrial network connected to the controller, could be placed in jeopardy. The result of which, either intentional or otherwise, may have dire consequences for an Industrial facility and may even cause the company to suffer unacceptable losses, such as the closure of a plant or facility.

In order to combat unauthorized use of remote resources, a variety of methods are known for authenticating a user during a login procedure. Typically, the authenticating system employs a user database containing all authorized users along with their specific user profiles. When a logon procedure is requested by an unknown remote user, the authenticating system cross-checks the user information and password against the user profile information in the database. In addition, it is common for the user profiles to contain all the information necessary to the system in order to control a user's access to any object or any operation provided by the system. This information is employed by the authenticating system to deny or grant access to objects and operations in the system.

The authenticating procedure for normal on-line transactions is cumbersome enough. For PCS or MES solutions in particular, the authenticating procedure can be overly burdensome. Unlike normal on-line transactions that are based on the same software package, PCS or MES solutions are tailored to specific customer needs. For this reason, user management and authentication issues can be very different from customer to customer, or between different categories of applications or a different market with regard to PCS or MES. As a result, authenticating a PCS or MES user can be prohibitively difficult.

It is therefore desirable that the user management service provides a comprehensive and at the same time flexible way to configure user profiles and to configure access policies for any object of the system—with any required level of granularity. In particular to PCS or MES, it is desirable to provide a more consistent, yet flexible, authenticating system.

It is further desirable that any implementation of such a user management service can be performed without requiring heavy changes to the software packages used in the system. Further it is desirable to provide a centralized environment to configure access policies.

For example, the security mechanisms provided by windows NT/2000 are used in known process control systems or MES packages. However, such systems are typically too complex. Alternatively, relatively simple proprietary user management functions are used. In the latter case, users are normally identified by a numerical number—normally called “access level”. This number is assigned to different objects (graphical displays, alarms, tags, files and so forth), or used within scripting languages to limit user access to specific objects or functions. Problematically, a drawback of this approach is that it requires providing software applications that are “enabled” to handle this access level in a proper and flexible way.

A further drawback of this approach is that it cannot cope with all the requirements of the different customers within an industry category or different industries categories, particularly with PCS or MES. In fact, a users access management is basically embedded in any software package in a somewhat fixed way. And, it is not possible to satisfy any customer needs. This means that the customer must adapt his user management needs to the system. Instead of having a system that can be configured to adapt itself to the customer's needs.

A further disadvantage of known systems is that user access configuration is not centralized and, thus, requires a large amount of information technology support resources.

### OBJECTS & SUMMARY OF THE INVENTION

It is, therefore, an object of the present invention to provide an improved computer system and method for managing access to resources of a remote user and/or a group of users.

The invention is particularly advantageous in that is allows to efficiently manage user access to resources and at the same time provide the highest level of flexibility.

In accordance with the invention, this is accomplished by means of script files being accessible by a centralized user manager program. The script files contain information descriptive of a user resource. By means of the script files it is possible to create, modify and update a user profile by editing his or her assigned script file. A script file can be optionally assigned to an individual user or to a group of users in order to assign rights to either an individual user a group of users.

In accordance with another aspect of the invention, named resources are employed. Resources are “operations” that are executed by system objects. Some operations are object specific, such as alarm acknowledging, tag write access etc., or can be more generic, e.g. modify configuration, save file, open file, etc. In the invention, a set of resources is assigned to each user profile. Any user can access all the resources specified in its assigned user profile, i.e., the user can perform all the operations corresponding to the enabled resources.

It is a further advantage of the present invention that each resource has a different access level in different user profiles. In this manner, access levels are assigned to specific objects, such as files, tags, etc., handled by different system packages. Named resources correspond to any entity in this system (objects, operations, files, logical entities, physical entities, etc.) that can be engineered, configured, operated and displayed by the software packages. The access policies to these named resources are configured by writing one or more script files.

It is a further advantage of the present invention to employ a simple syntax f(or the script files) and manage the script files centrally by a user management service. When a script file is needed by a particular user after login, the corresponding script file is automatically aligned on the client workstation.

With the present invention, the configuration of the access policies are performed in a centralized way for any object handled by the system. This system more easily adds new classes of resources and handles third party resources in a flexible way. New policies and objects are added rather quickly, in a centralized way, without any reconfiguration of the software packages, thus allowing easier scalability by the user management service. The flexibility of the system is quite total, as it allows the customer (or system integrator) to develop even the most complex user authentication policies, with editing text files kept at a minimum or eliminated altogether.

In particular, the invention allows to assign to each user profile or each single user a script file containing the list of named resources that can be accessed by the user or all users of that profile.

In accordance with the invention, named resources are identified by a qualifier to indicate the resources class such as graphic display and area, plant unit, alarm group, etc., and a flag indicating the access type, such as enable access or deny access.

In accordance with a further preferred embodiment of the invention the script file is a normal text file with a simple syntax. A user manager tool assigns the proper script file to any user or any user group.

When a user logs on to the system, the assigned script files are loaded locally on the workstation, so that they can be used by the user management service to authenticate it and to enable or deny access to specific objects or operations. Users can have more scripts assigned (as they can belong to more user profiles). The user manager tool will merge all the script files and will perform a consistency check.

### BRIEF DESCRIPTION OF THE DRAWINGS

In the following preferred embodiments of the invention are described in greater detail by making reference to the drawings in which:

FIG. 1. is a block diagram of an embodiment of a computer system in accordance with the invention;

FIG. 2. is flow diagram for managing access of a user to resources in accordance with the invention;

FIG. 3. is a block diagram of the computer system after login, when a user requests access to a resource; and

FIG. 4. is a flow diagram of the operation of the computer system.

### DETAILED DESCRIPTION OF THE PREFERRED EMBODIMENTS

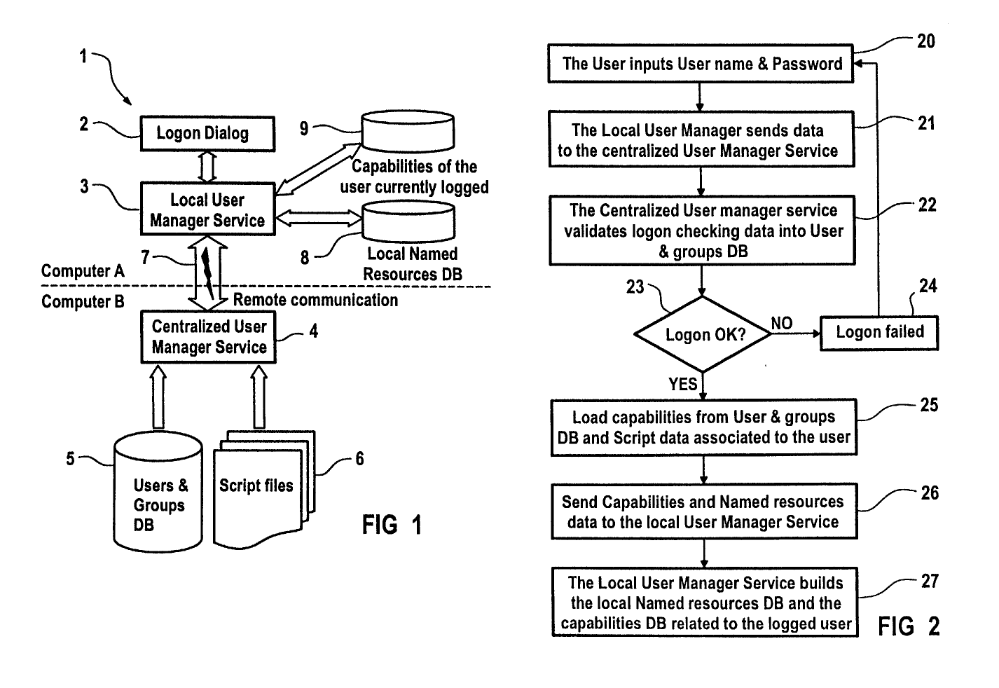

FIG. 1 illustrates a computer system 1 comprising a central computer B and at least one user workstation computer A. In summary, the computer A comprises a logon dialog component 2, which is coupled to a local user management application (program) 3. The local user management program provides for local user manager services. The computer B has a centralized user manager application (program) 4, which is coupled to a user database 5 and to a database 6 containing a number of script files. Each of the script files contains information descriptive of a user resource and is assigned to a user or to a group of users within the user database 5.

In operation, the user initiates the logon operation by inputting his or her user name and password into the logon dialog component 2. The user name and password is forwarded to the local user manager application 3 which sends this data to the centralized user manager application 4 of the computer B via a data link 7. As will be appreciated by those skilled in the art, the data link can be any remote communication link, including the Ethernet, Internet or other on-line communication network. In response to receiving, the application 4 performs an access operation to the user database 5 in order to search the user database 5 for an entry of this user name and compares the password entered by the user into the logon dialog component 2 with a password stored in relation to the user name in the user database 5. If the logon procedure failed, i.e., the username and/or the password does not match, the application 4 provides a message to the application 3. The failure message in one aspect of the invention is displayed in the logon dialog component 2 to prompt the user to re-enter its correct user name and password.

If the logon procedure was successful the centralized application 4 loads at least one or more script files from the database 6 pertaining to the logged-in user. In an aspect of the invention, the application 4 loads a description of user capabilities contained in a user profile stored in the user database 5. It shall be appreciated that it is advantageous that the script files contain named resources in order to identify those resources to which the user has access permission. In another aspect of the invention, the script files contain qualifiers for each resource in order to specify an allowed user action which a user may perform on the resource.

The information obtained from the database 5 and the database 6 is transmitted over the data link 7 to the computer A from the centralized application 4. In response, the remote application 3 creates an entry into a local named resources database 8 and a database 9 for storing the capabilities of the currently logged-in user. In an aspect of the invention, both databases 8 and 9 are locally stored on the computer A for direct access by the program 3.

In order to obtain the named resources of the logged-in user, the corresponding script or scripts are parsed. In an aspect of the invention the parsed script may be employed to identify corresponding qualifiers, i.e., the access rights for the specified resources.

FIG. 2 is a flow chart that illustrates the user logon procedure and script managing operation. In step 20, the user inputs his or her user name and password into the login dialog component. In step 21, the local user management program sends the user name and password to the centralised user manager program. Next, in step 22, the centralized user manager program validates the login information by accessing the user database and comparing the user name and password provided by the user with the corresponding information stored in the database.

In step 23, it is decided by the centralized user manager program whether the logon information provided by the user is authentic. If it is not authentic, a message is created in step 24 and displayed to the user. When this occurs, control is passed back to step 20 for a renewed login attempt by the user.

If the login is authentic, the user capabilities are loaded by the centralized user manager program from the user profile contained in the user database. Further, the script file (or the script files) being assigned to the user are loaded by the centralized user manager program. The data contained in the script (or the scripts) are parsed in order to extract the named resources associated to the user and the corresponding qualifiers.

In step 26, the capabilities and the named resources data are sent from the centralized user manager program to the local user management program on the users workstation. In step 27, the local user management program creates the local named resources database and the capabilities database related to the logged-in user based on the information provided from the centralized user management program. One skilled in the art will readily understand the basic procedures for creating databases.

FIG. 3 depicts a further aspect of the invention. Elements of the computer system of FIG. 3 which correspond to elements of the system of FIG. 1 are denoted by the same reference numerals.

In addition to the computer system of FIG. 1, the computer system of FIG. 3 includes a database 30, which stores the capabilities of all users currently logged-in. In other words, the database 30 is the summation of all databases 9. In this manner, the database 30 centrally reflects the capabilities of all users being logged-on at a given point of time.

FIG. 3 shows the computer system 1 in a state where the user has already logged-on and the databases 8 and 9 have been created. When the user requests access to a system resource by means of application program 31, this request is input into the local user management application (program) 3.

In response, the local application 3 searches the local databases 8 and 9 in order to determine whether this user has the required access permissions for the requested resource. It is to be noted that this does not require access to the centralized user management program 4 as the required data is already locally stored in the databases 8 and 9. This is the advantage of increased response times and limitation of network traffic.

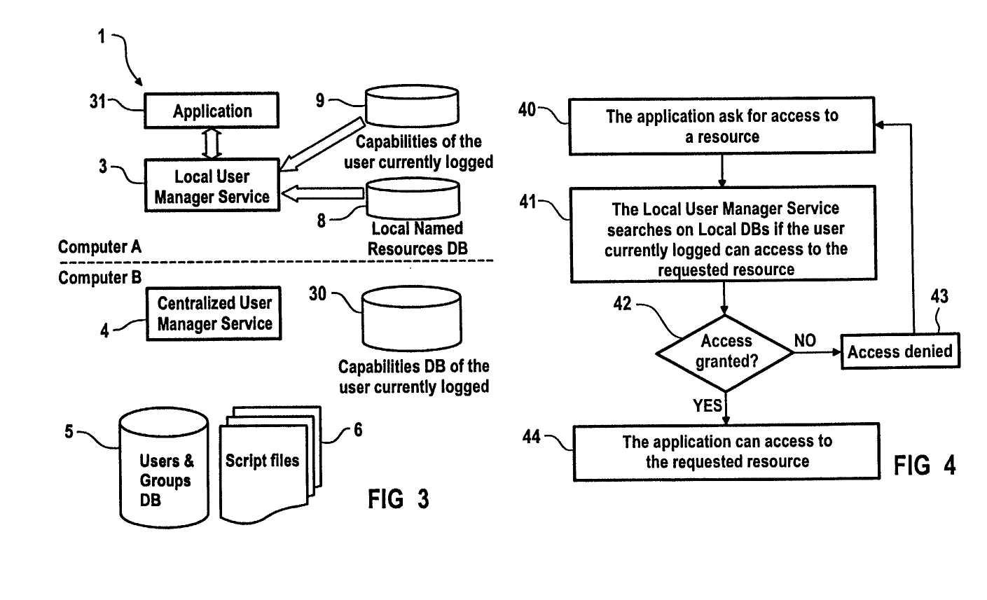

FIG. 4 depicts a flow chart of the operation corresponding to FIG. 3. In step 40, the application requests access to a system resource. In step 41, the local user management program searches the databases 8 and 9 and, in step 42, determines if the logged-on user has access permission to the requested resource. If the user does not have sufficient access rights, access is denied in step 43 and control is passed back to step 40.

If the contrary is the case, the application is granted access to the requested resource. Advantageously, this procedure does not require access to the computer B (cf. FIG. 3) as the required information is locally stored on the users workstation. This speeds up the granting of access to a requested resource and also increases the reliability of the system. For example, considering interruptions in the data transmission between computer A and computer B in a manufacturing environment, the present invention is virtually immune from delays caused thereby due to the locality of the access information.

In accordance with an aspect of the invention, each script file contains a list of named resources that can be accessed or cannot be accessed by the user. Resource qualifiers are employed to identify the resource class (it would be possible to have two resources with the same name, but a different meaning). In one aspect, resource qualifiers may be alphanumeric strings with a prefix (“.”). E.g. .Action (jser action), .Unit (plant unit), etc. In another aspect, some or all of the qualifiers may correspond to file extensions (if they indicate a file category). In the former case, the Action qualifier is used for the predefined resources (i.e. the resources already handled by the older user management system).

Below are listed examples of actions and their corresponding script(s). In so setting forth the examples, the following should be kept in mind.

a) The action “Tag setting” may be applied to a list of pant areas or graphic displays.

b) The action “Modify and Save file” could be applied to all programming languages files, but not to the graphic displays files.

c) As far as the Action qualifier is concerned, if no flag is provided, the “Access enabled” flag is considered by default. This may have different meanings depending on the resource (“open” for a file, “modify” for a project, etc.) Script files may also include comments (for example, preceded by a #).

Examples of Qualifiers

.MPO #Master Production Operations

.GRC #Graphic displays

.UnitName #Plant Unit (a RealTimeDataBase, a controller, . . . )

.AreaName #Plant area

.HDD #Historical Data Display file

.ASD #Alarm Summary Display file

.MSP #Material Specification

.CIF_LIB #Cube Industrial Framework Modeler Library

To deny access to a resource, the “!” symbol may, for example, be used. If it is the only symbol in the text line, it may mean, for example, that it denies access to all the resources listed in the following lines (until another symbol, for example, the “+” symbol, is used).

A qualifier may be concatenated to the resource name, or be placed on a separate line. In this second case, it is understood to be the default qualifier for all the following lines (until the next qualifier).

Example

.GRC #Graphic display

Area1.AreaName #Plant Area qualifier

!Page1 #Access to graphic display files “Page1”, Page2”, “Page3” is denied within Area 1

!Page2

!Page3 #Access to all other graphic display files is enabled within

Area 1

Area2.AreaName

Page1 #Access to graphic display file “Page” and “Page7” is enabled within Area 2

Page7 #Access to all other display files is denied within Area 2

The same policy can be expressed in the following way:

.GRC

Area1.AreaName

!

Page1

Page2

Page3

+#Closes the previous “!” qualifier

Area2.AreaName

Page1

Page7

If the named resources is a file name, it is preferred in the invention to include the file path. It is possible, of course, to put the file path on a separate text line using the prefix “<”. In this case, it is used as default file path for all the following named resources with no file path.

Example

.GRC

<PlantName\HMI\Area1\GRAPH\COMP

!

Page1

Page2

Page3

With some specific predefined qualifiers, it is not necessary to include the file path, as it is automatically determined by the system.

Named resources can contain “wild chars” (“*” and “!”). This can reduce the amount of the text lines needed to build a script file.

Example

Area1.Area Name

!PL3*.GRC #Within Area1, access to all graphic displays whose file name begins with “PL3” is denied

Examples of Actions Configuration

TagReadOnly.Action #Read only access to tags . . .

.GRC # . . . from graphic displays . . .

Area1.ZoneName # . . . within Area1

Page1 #Applied only to Page1, Page2 and Page3

Page2

Page3

TagReadOnly.Action #Read only access to tags . . .

.GRC # . . . from graphic displays . . .

Area1 .ZoneName # . . . within Area1

!Page1 #Applied to all graphic displays except to Page1, Page2 and Page3

!Page2

!Page3

.GRC #From graphic displays

.Area1.AreaName # . . . within Area1 . . .

!Page1 # . . . access is denied to Page1, Page2 and Page3, and

!Page2

!Page3

TagReadOnly.Action # . . . write access to tags is denied for Page7, Page8 and Page9

Page7

Page8

Page9 #All other graphic displays can be accessed and have write access to tags.

While the present invention has been described within the context of the above one or more embodiments, it will be appreciated that the one or more of the several features of the invention includes equivalents which are within the scope of the invention.

1. A system for managing access of a remote user to downloadable resources, comprising:
a central computer, including,
a first database for storing user information;
a script file containing information establishing access rights of said user to a user resource; and
a centralized user manager program for accessing the first database and the script file, and downloading the script file to the remote user.

2. The system according to claim 1, further comprising a remote computer being remotely coupled to the central computer.

3. The system according to claim 2, that executes a local user management program that creates a local resource database for a user after login of the user.

4. The system of claim 3, wherein the local user management program loads the script files from the central computer.

5. The system of claim 2, wherein the local user management program creates the local resources database based on the script file.

6. The system of claim 1, wherein the script file includes a qualifier representative of the type of access granted to the user of a particular resource.

7. The system of claim 1, wherein the central computer is coupled to the remote user through the Internet.

8. A system for managing access of a remote user to downloadable resources, comprising:
a remote computer, including:
a first database for storing user information;
a script file containing information establishing access rights of said user to a user resource; and
a localized user manager program for accessing the first database and the script file, and downloading the script file from a centralized computer located remotely from said remote computer.

9. The system according to claim 8, further comprising a central computer being remotely coupled to the remote computer.

10. The system according to claim 9, that executes a local user management program that creates a local resource database for a user after login of the user.

11. The system of claim 8, wherein the script file includes a qualifier representative of the type of access granted to the user of a particular resource.

12. The system of claim 8, wherein the remote computer is coupled to the central computer through the Internet.

13. A method for managing access of a remote user to downloadable resources, comprising the steps of:
in a central computer:
storing user information in a first database;
generating a script file containing information establishing access rights of said user to a user resource;
accessing the first database and the script file; and
downloading the script file to the remote user.

14. The method of claim 13, in a remote computer located remotely from the central computer, further comprising the step of building a local database from the script file at a location of the remote computer that indicates the access rights of the user to the user resource.

15. The method of claim 13, further comprising the step of executing a local user management program that creates a local resource database for a user after login of the user.

16. The method of claim 15, further comprising the step of the local user management program loading the script files from the central computer.

17. The method of claim 15, further comprising the step of the local user management program creating the local resources database based on the script file.

18. The method of claim 13, further comprising the step of including in the script file a qualifier representative of the type of access granted to the user of a particular resource.

19. The method of claim 13, further comprising the step of coupling the central computer to the remote user through the Internet.

20. A computer product incorporating instructions for driving a computer according to a process set forth by the method of claim 13.
